(19) United States
(12) Patent Application Publication
(10) Pub. No.: US 2014/0223355 A1
(43) Pub. Date: Aug. 7, 2014

(54) Customizable and Interactive Book System

(71) Applicants: Dominique Raccah, Naperville, IL (US); Joe Wein, Highland Park, IL (US); Marc Cain, Chicago, IL (US); George A. White, Walnut, CA (US)

(72) Inventors: Dominique Raccah, Naperville, IL (US); Joe Wein, Highland Park, IL (US); Marc Cain, Chicago, IL (US); George A. White, Walnut, CA (US)

(73) Assignee: SOURCEBOOKS, INC., Naperville, IL (US)

(21) Appl. No.: 14/232,126

(22) PCT Filed: Jul. 10, 2012
(86) PCT No.: PCT/US2012/046090

§ 371 Date: Apr. 7, 2014

Related U.S. Application Data
(60) Provisional application No. 61/506,507, filed on Jul. 11, 2011.

(51) Int. Cl. G06F 3/0483

(52) U.S. Cl. CPC G06F 3/0483
USPC 715/776

(57) ABSTRACT

Methods, servers, and devices for customizing a customizable book are disclosed. An example method includes providing an application on a device, and receiving from the device via the application a selection of a book from a plurality of books. The book includes a plurality of customizable fields. The method further includes receiving from the device via the application a selection of at least one customizable field in the plurality of customizable fields, for each of the at least one selected customizable fields, receiving from the device via the application a customization of the selected customizable field, and, based on the customization for each of the at least one selected customizable fields, customizing the book to produce a customized book. The customized book may be shared with one or more additional users and/or printed.

### CROSS-REFERENCE TO RELATED APPLICATION

This application claims priority to U.S. Provisional Patent Application Ser. No. 61/506,507 filed Jul. 11, 2011, the entire contents of which are hereby incorporated by reference.

### BACKGROUND

Parents and other caregivers are often in search of ways to amuse children. Two common means of amusing children are by providing digital content (e.g., through a television, computer, or mobile device) and reading a book to the child. While effective at amusement, providing digital content is in some cases distasteful to parents and caregivers because of its lack of personal contact and the limited ability of parents and caregivers to select digital content. Further, while also effective at amusement, some children are unable to read independently, and reading a book with a child takes time that many busy parents and caregivers cannot provide.

### SUMMARY

Accordingly, there may be a desire for customizable digital content for children. Through customization and, in some cases, narration by a parent or caregiver, the customizable digital content may provide an improved substitute for personal contact during times that parents and caregivers are busy. Further, the customizable digital content may allow parents and caregivers an improved ability to select and customize digital content.

In one aspect, a method is disclosed that includes providing an application on a device, and receiving from the device via the application a selection of a book from a plurality of books. The book includes a plurality of customizable fields. The method further includes receiving from the device via the application a selection of at least one customizable field in the plurality of customizable fields and, for each of the at least one selected customizable fields, receiving from the device via the application a customization of the selected customizable field. The method still further includes, based on the customization for each of the at least one selected customizable fields, customizing the book to produce a customized book, receiving from the device via the application an indication of a plurality of additional users, and, for each additional user in the plurality of additional users, identifying an additional device associated with the additional user and providing the customized book to the additional device via an additional based application on the additional device. The method further includes causing the customized book to be printed.

In another aspect, a server is disclosed that includes at least one interface, at least one processor, and data storage comprising a plurality of books and instructions. The instructions are executable by the at least one processor to provide via the at least one interface a web-based application on a device, and receive from the device via the web-based application a selection of a book from the plurality of books. The book includes a plurality of customizable fields. The instructions are further executable by the at least one processor to receive from the device via the web-based application a selection of at least one customizable field in the plurality of customizable fields and, for each of the at least one selected customizable fields, receive from the device via the web-based application a customization of the selected customizable field. The instructions are still further executable by the at least one processor to, based on the customization for each of the at least one selected customizable fields, customize the book to produce a customized book, and to receive from the device via the web-based application an indication of a plurality of additional users. The instructions are further executable by the at least one processor to, for each additional user in the plurality of additional users, identify an additional device associated with the additional user and provide the customized book to the additional device via an additional web-based application on the additional device, and to cause the customized book to be printed.

In yet another aspect, a device is disclosed that includes at least one interface configured to facilitate provision by a server of a web-based application, at least one processor, and data storage comprising instructions. The instructions are executable by the at least one processor to receive via the web-based application a selection of a book from a plurality of books. The book includes a plurality of customizable fields. The instructions are further executable by the at least one processor to receive via the web-based application a selection of at least one customizable field in the plurality of customizable fields and, for each of the at least one selected customizable fields, receive via the web-based application a customization of the selected customizable field. The instructions are further executable by the at least one processor to receive via the web-based application a selection of a plurality of additional users, and provide to the server via the at least one interface indications of the book, the at least one customizable field, the customization for each of the at least one selected customizable fields, and the plurality of additional users. The instructions are further executable by the at least one processor to, in response to providing the indications to the server, receive from the server via the at least one interface a confirmation that the customized book has been provided to each additional user in the plurality of additional users and a confirmation that the customized book has been printed.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

FIG. 1 shows an overview of an embodiment of an example system.

FIG. 2 shows a block diagram of an example server, in accordance with an embodiment.

FIG. 3 shows a block diagram of an example device, in accordance with an embodiment.

FIG. 4 shows a flow chart of an example method for customizing a book, in accordance with an embodiment.

FIG. 5 shows a flow diagram of an example method for customizing a book, in accordance with an embodiment.

FIGS. 6A-F illustrate an example application of the method shown in FIG. 4, in accordance with an embodiment.

FIG. 7 illustrates an example additional web-based application, in accordance with an embodiment.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method embodiments described herein are not meant to be limiting. It will be readily understood that certain aspects of the disclosed systems and methods can be arranged and combined in a wide variety of different configurations, all of which are contemplated herein.

### 1. Overview

Disclosed are methods and systems for customizing books. The books may be customized using, for example, an application downloaded to a device or using a web-based application and/or a website provided on a device by a server. Through the local application or web-based application and/or website, a user may customize the book to include, for example, names, places, images, and/or objects of the user's choosing. The application or server may receive the user's customizations to the book, and may responsively customize the book to produce a customized book.

Once the book is customized, the user may share the customized book with one or more additional users through the web-based application and/or website and/or through email (e.g., with a link to access the customized book and/or a “screen capture” of a page of the customized book, etc.) or a server. To this end, the user may select the additional users through the web-based or local application, and the server may provide the customized book to each of the additional users. In particular, the server may provide the customized book to each additional user through an additional web-based or local application and/or website provided on an additional device associated with the additional user and/or through an email address associated with the additional user.

Additionally, once the book is customized, the user may receive a request to print a printed version of the customized book. To this end, the server may cause the customized book to be printed (e.g., at an affiliated printer) and the printed customized book may be provided to the user.

### 2. Example Architectures

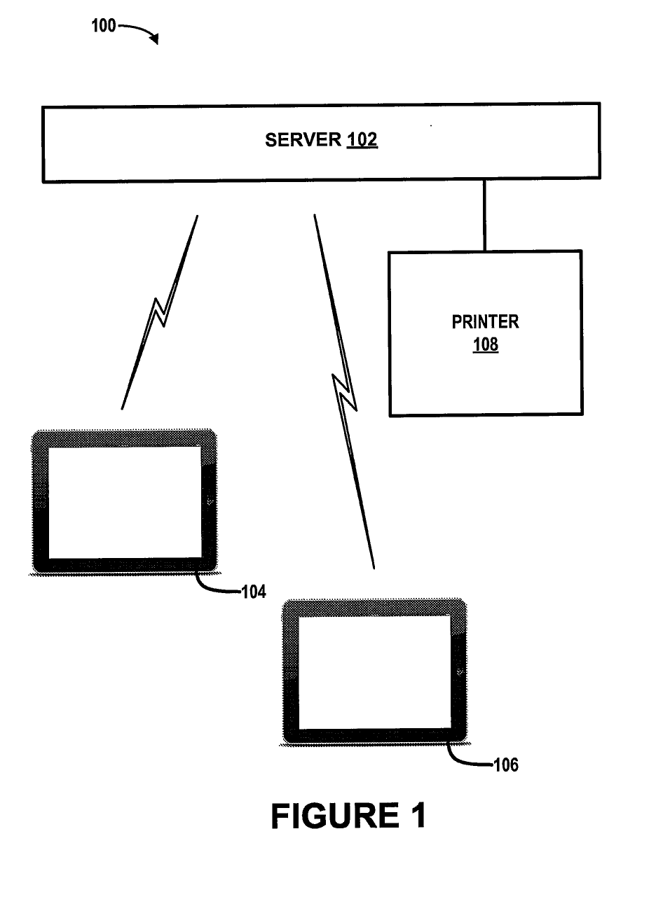

FIG. 1 shows an overview of an embodiment of an example system 100. As shown, the system 100 includes a server 102, a device 104, an additional device 106, and a printer 108. While the system 100 is shown to include only one server 102, one device 104, one additional device 106, and one printer 108, more servers, devices, additional devices, and printers are possible as well. Further, the system 100 may additionally include elements other than those shown.

The server 102 may be a computer or network of computers configured to provide a web-based application on the device 104 or to provide an application downloadable to the devices 104 and 106. The device 104 may be any computing device configured to execute the web-based application provided by the server 102. To this end, the device 104 may take the form of, for example, a laptop computer, a tablet computer, and/or a mobile device. The device 104 may take other forms as well.

A user of the device 104 may use the web-based or local application on the device 104 to customize a book. To this end, the server 102 may provide the device 104 with a listing of a plurality of books that may be customized by the user. The device 104 may display the listing of the plurality of books to the user through the web-based or local application, and the user may select a book from the listing of the plurality of books. The device 104 may provide an indication of the selected book to the server 102.

The selected book may include a plurality of customizable fields through which the user may customize the book. Accordingly, the server 102 may provide the device 104 with a listing of the customizable fields. The server 102 may provide the listing of the customizable fields to the device 104 along with the listing of the plurality of books or in response to receiving the indication of the selected book.

The device 104 may display the listing of the customizable fields to the user through the web-based or local application, and the user may select customizations for some or all of the customizable fields in the book. The device 104 may provide indications of the customizations to the server 102. Upon receiving the indications of the customizations, the server 102 may customize the book based on the customizations, thereby producing a customized book. Alternatively, in other examples, the local application on the device may perform customizations locally.

In some embodiments, the server 102 may provide the customized book to the device 104, and the user may view the customized book on the device 104 through the web-based application. To this end, the device 104 may download all or a portion of the customized book and display the customized book through the web-based application on the device 104. The device may, for example, download a first page and a following page of the customized book. Downloading a page may be understood to refer to downloading the predetermined text, graphics, and/or audio of the page as well as any customizations for the page.

As the user turns from the first page to the following page on the device 104, the device 104 may retain the first page and may additionally download a page following the following page. Thereafter, the device 104 may continue to cache a current page (that is, a page that the user is currently viewing) as well as one or more previous pages and one or more following pages. This may be achieved using, for example, a mirrored SQL database. The device 104 may display the customized book through the web-based application on the device 104 in other manners as well.

Alternatively or additionally, in some embodiments the device 104 may receive from the user through the web-based application a selection of one or more additional users with whom the customizer wishes to share the customized book. Upon receiving the selection of the plurality of additional users, the device 104 may provide indications of the plurality of additional users to the server 102. The server 102 may identify additional devices, such as the additional device 106, associated with each of the plurality of additional users, and may provide the customized book to each of the additional devices, including additional device 106.

To this end, the server 102 may, in some embodiments, be configured to provide an additional web-based or local application on the additional device 106, and the additional device 106 may be any computing device configured to execute the additional web-based application provided by the server 102. In other embodiments, the server 102 may provide the customized book to the additional device 106 through an email address associated with the additional user and/or the additional devices 106. The server 102 may provide the customized book to the additional device 106 in other manners as well. In any case, the additional device 106 may take the form of, for example, a laptop computer, a tablet computer, and/or a mobile device. The additional device 106 may take other forms as well.

Still alternatively or additionally, in some embodiments the server 102 may cause the customized book to be printed, and the user may receive the printed customized book. To this end, the server 102 may instruct a printer 108, such as a printer that is affiliated with the server 102, to print the customized book and mail the printed customized book to the customizer and/or have the printed customized book available for pick up by the customizer. The server 102 may cause the customized book to be printed in other manners as well.

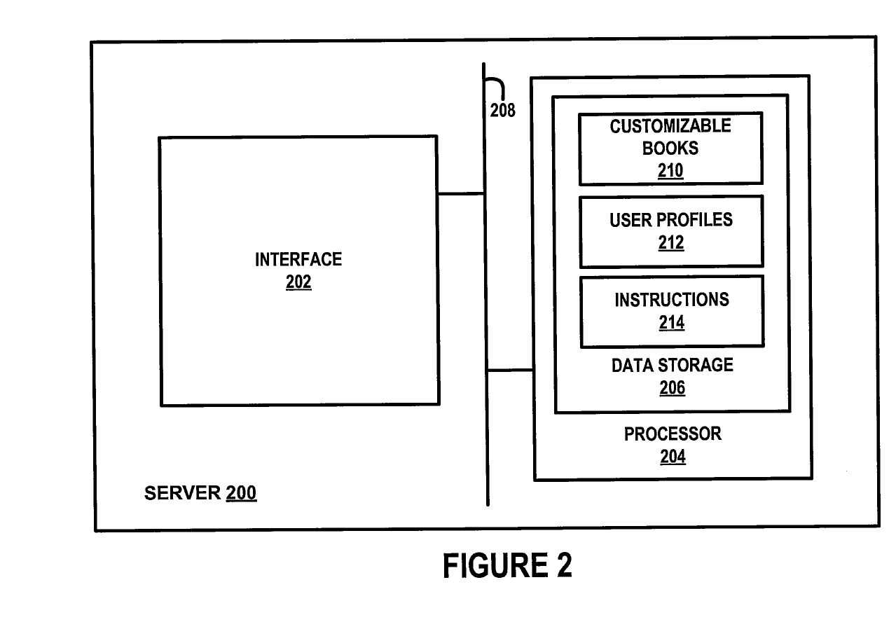

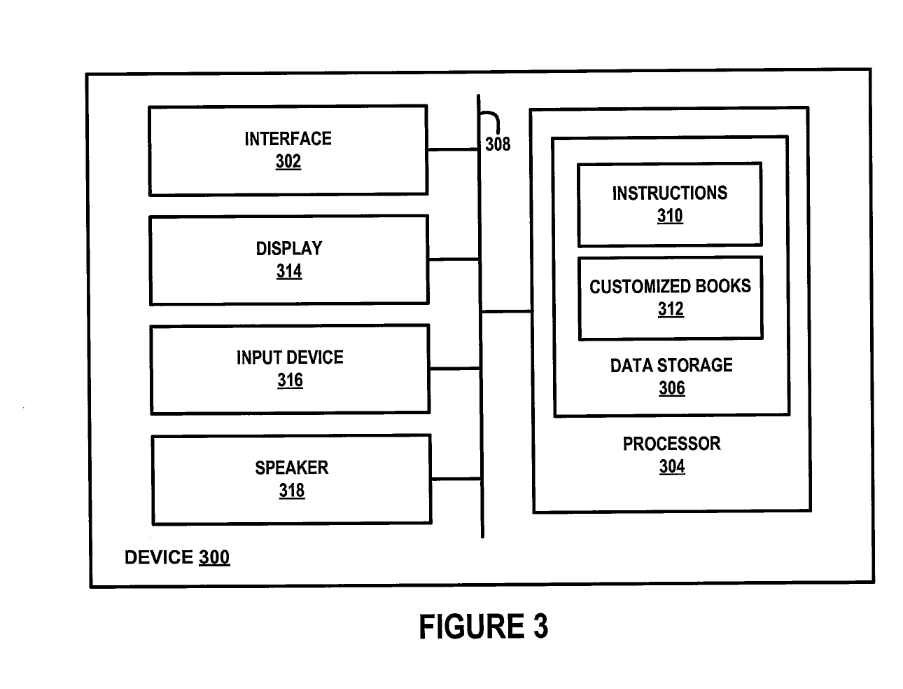

An example server is further described below in connection with FIG. 2, and an example device is further described below in connection with FIG. 3.

FIG. 2 shows a block diagram of an example server 200, in accordance with an embodiment. The server 200 may be, for example, a computer or a plurality of computers on which one or more programs and/or applications are run in order to provide one or more web-based applications or downloadable applications that are accessible by devices via, for example, a packet-switched network. The web-based applications may, for example, take the form of one or more websites provided by the server 200 and accessible by the devices and/or applications or programs supported by the server 200 and executable on the devices. To this end, server 200 may be, for example, a web server configured to deliver HypertText Markup Language (HTML) documents to one or more devices via the packet-switched network in response to a request, such as a HyperText Transfer Protocol (HTTP) request, from the devices. The server 200 may take other forms as well.

As shown, the server 200 includes an interface 202, a processor 204, and data storage 206, all of which may be communicatively linked together by a system bus, network, and/or other connection mechanism 208.

The interface 202 may be any interface configured to provide a web-based application on a device, as well as an additional web-based application on each of a plurality of additional devices. To this end, the interface 202 may be, for example, a wireless interface and may include an antenna and a chipset for communicating with the device and the additional devices over an air interface. The chipset or interface 202 in general may be arranged to communicate according to one or more other types of wireless communication (e.g. protocols) such as Bluetooth, communication protocols described in IEEE 802.11 (including any IEEE 802.11 revisions), cellular technology (such as GSM, CDMA, UMTS, EV-DO, WiMAX, or LTE), or Zigbee, among other possibilities. The interface 202 may take other forms as well.

The processor 204 may comprise one or more general-purpose processors and/or one or more special-purpose processors. To the extent the processor 204 includes more than one processor, such processors could work separately or in combination. Further, the processor 204 may be integrated in whole or in part with the interface 202 and/or with other components.

Data storage 206, in turn, may comprise one or more magnetic, optical, organic, or other storage components, whether volatile or non-volatile. In an embodiment, data storage 206 may be external to the server 200, such as in a local database directly connected to the server 200 or in a remote database accessible by the server 200 via the Internet.

Data storage 206 may include a plurality of customizable books 210. The plurality of customizable books 210 may be customizable by a user, as described above. To this end, each of the customizable books may include predetermined text and/or graphics along with one or more customizable fields. The customizable fields may include, for example, customizable text fields, customizable graphics fields, and customizable audio fields. For instance, the customizable text fields may include a title of the customizable book, an author of the customizable book, a dedication of the customizable book, character names, location names, and/or object names. Other customizable text fields are possible as well. Further, the customizable graphics fields may include a cover appearance of the customizable book, fonts used in the customizable book (including font type, size, color, etc.), a page-turn appearance of the customizable book, character appearances, location appearances, and object appearances. Other customizable graphics fields are possible as well. Still further, the customizable audio fields may include narration of the customizable book (e.g., follow-along narration with word highlighting), a dedication of the customizable book, background music of the customizable book, a page-turn sound of the customizable book, and sound effects of the customizable book. Other customizable audio fields are possible as well.

Data storage 206 may further include user profiles 212. The user profiles 212 may include, for example, a profile for the user and profiles for each of the additional users. Each profile may include, for example, a name of a user (or additional user) associated with the device (or additional device), an email address for the user, payment information for the user, a mailing address for the user, an age of the user, a reading level of the user, appearance information for the user (e.g., a photograph or an avatar, or attributes, such as brown hair, blue eyes, etc.), preferences for the user (e.g., preferred genres, preferred authors, etc.), customized books previously customized by the user, and customized books previously shared with the user. The user profiles may include other information as well.

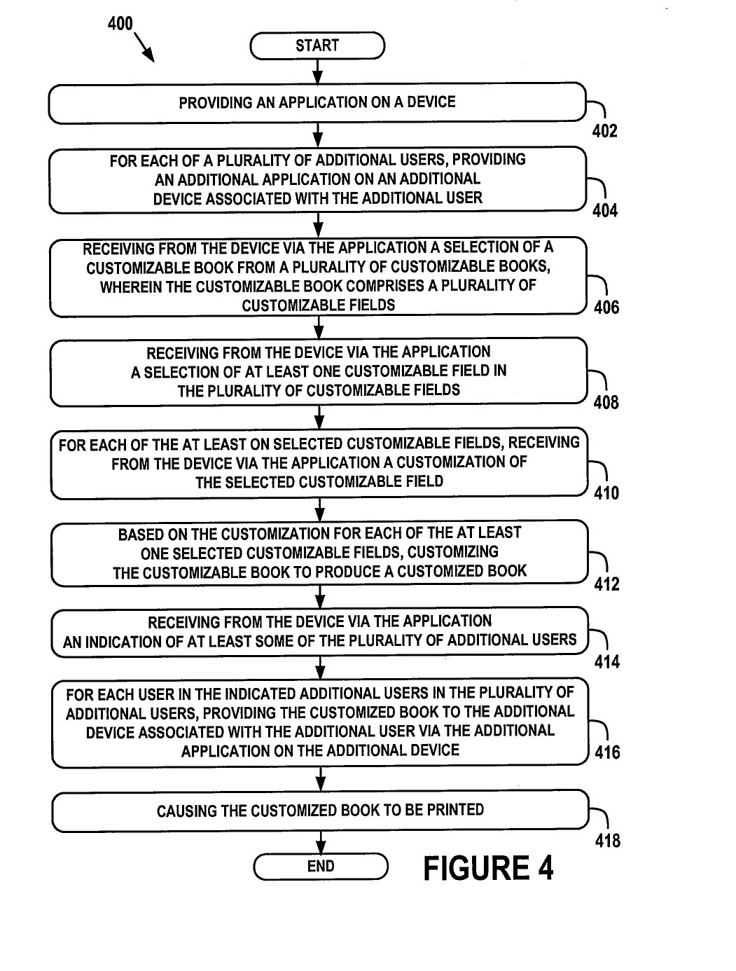

Further, data storage 206 may include instructions 214 executable by the processor 204 to carry out various server functions, including those described below in connection with FIG. 4. In particular, the instructions 214 may be executable by the processor 204 to facilitate customization of a customizable book from the customizable books 210 to produce a customized book, and to associate the customized book with a user profile in the data storage 206. The instructions 214 may be executable by the processor 204 to carry out other server functions as well.

Data storage 206 may include additional program logic as well. Further, the server 200 may include one or more components instead of or in addition to those shown.

FIG. 3 shows a block diagram of an example device 300, in accordance with an embodiment. The device 300 may be any device configured to access a web-based or downloadable application provided by a server via, for example, a packet-switched network. To this end, the application may take the form of, for example, a mobile application or other software designed to run on the device 300. The application may be pre-stored on the device 300, or may be downloaded from, for example, the server via, for example, the packet-switched network. In any case, the application may be configured to support a wireless connection between the device 300 and the server.

As shown, the device 300 includes an interface 302, a processor 304, and data storage 306, all of which may be communicatively linked together by a system bus, network, and/or other connection mechanism 308.

The interface 302 may be any interface configured to access the application provided by a server. To this end, the interface 302 may be, for example, a wireless interface and may take any of the forms described above for the interface 202. The interface 302 may take other forms as well.

The processor 304 may comprise one or more general-purpose processors and/or one or more special-purpose processors. To the extent the processor 304 includes more than one processor, such processors could work separately or in combination. Further, the processor 304 may be integrated in whole or in part with the interface 302 and/or with other components.

Data storage 306, in turn, may comprise one or more magnetic, optical, organic, or other storage components, whether volatile or non-volatile. As shown, the data storage 206 includes instructions 310 and customized books 312.

The instructions 310 may be executable by the processor 304 to carry out various device functions. In particular, the instructions 310 may be executable by the processor 304 to execute a web-based or local application through which a customizable book, such as a customizable book from the customizable books 210 described above, may be customized to produce a customized book. The instructions 310 may be executable by the processor 304 to carry out other server functions as well.

Once a customized book is produced, the device 300 may store the customized book along with other customized books 312 in the data storage 306. For each customized book in the customized books 312, the device 300 may store the entirety of the customized book, may store only a portion of the book, or may store only an indication of the customized book. In embodiments where the device 300 stores only a portion or only an indication of the customized book, the remainder or entirety of the customized book may be stored at the server, and the device 300 may download the remainder or entirety of the customized book (either all at once or in portions) as needed and/or requested by a user of the device.

In some embodiments, the device 300 may additionally include a display 314. The display 314 may be configured to display a graphical user interface for the application. The display 314 may be further configured to display, through the application, one or more of a listing of customizable books that may be customized through the application, a listing of customizable fields included in the customizable books, and a listing of a plurality of additional users from which a user of the device 300 may select additional users with whom to share a customized book. The display 300 may be configured to display other information as well, both through and outside of the application. To this end, the display 314 may be any type of display, such as flat panel, liquid crystal, plasma, touchscreen, or other display. In embodiments where the display 314 is a touchscreen, the display 314 may be further configured to receive input from a user of the device 300, including, for example, a selection of a customizable book from the listing of customizable books, customizations of the customizable fields, and a selection of the additional users from the listing of the plurality of additional users with whom the user of the device 300 wishes to share a customized book. The display 314 may take other forms as well.

In some embodiments, the device 300 may additionally include an input device 316. The input device 316 may be configured to receive any of the inputs from a user described above for the touchscreen. To this end, the input device 316 may include one or more of a keyboard, mouse, joystick, trackball, microphone, or other input device. The input device 316 may take other forms as well.

In some embodiments, the device 300 may additionally include a speaker 318. The speaker 318 may be configured to output one or more audio customizations and/or other audio for a customized book. For example, the speaker 318 may be configured to output one or more of narration for a customized book, a dedication for a customized book, page-turn sounds for a customized book, sound effects for a customized book, and background music for a customized book. The speaker 318 may be configured to output other audio as well, both through and outside of the web-based application.

The device 300 may include one or more components instead of or in addition to those shown.

### 3. Example Methods

FIG. 4 shows a flow chart of an example method 400 for customizing a book, in accordance with an embodiment. Method 400 shown in FIG. 4 presents an embodiment of a method that, for example, could be used with systems, servers, and devices described herein. Method 400 may include one or more operations, functions, or actions as illustrated by one or more of blocks 402-418. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 400 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 400 and other processes and methods disclosed herein, each block may represent circuitry that is wired to perform the specific logical functions in the process.

As shown, the method 400 begins at block 402 where a server provides an application to a device. The server, the device, and the application may take any of the forms described above. In one example, the device may download the application and access the application locally. In another example, the application may be a web-based application and the device accesses the web-based application via the server.

The method 400 continues at block 404 where, for each of a plurality of additional users, the server provides an additional application on an additional device associated with the additional user. The additional device and the additional application may take any of the forms described above in connection with the device and the web-based or local application.

At block 406, the server receives from the device via the application a selection of a customizable book from a plurality of customizable books. To this end, the server may provide the device with indications of some or all of the plurality of customizable books, and the device may display the indications in the application. The device may receive the selection of the customizable book from the plurality of customizable books from a user of the device through the application, and the device may provide the selection to the server. The server may receive the selection in other manners as well.

In some embodiments, the server may additionally provide the device with summaries and/or previews of each of some or all of the plurality of customizable books, so that the device may display the summaries and/or previews to aid the user of the device in making the selection. The summaries and/or previews may be provided along with the indications, or may be provided as needed by the device (e.g., as requested by the user of the device). The server may provide the device with other information about the plurality of customizable books as well.

Each of the customizable books may include a plurality of customizable fields. The customizable fields may include, for example, customizable text fields, customizable graphics fields, and customizable audio fields, as described above. Other customizable fields are possible as well.

Customizable text fields may be configured to receive text customizations. Customizable graphics fields may be configured to receive graphics customizations, such as photographs, videos, and animations. Customizable audio fields may be configured to receive audio customizations, such as audio files, music, and sound effects. Any of the customizations may be predetermined and stored at the server, stored on the device, or stored on another entity, such as a social networking server configured to provide a social networking site.

Some or all of the customizable fields may be configured to receive an alphanumeric customization from the user of the device. For example, a customizable text field for a title and/or a customizable text field for a character name may be configured to receive an alphanumeric customization from the user of the device specifying a title and a character name, respectively, for the customizable book. Other examples are possible as well.

Alternatively or additionally, some or all of the customizable fields may be configured to receive from the user of the device a selection of a predetermined customization from a listing of predetermined customizations. The listing of predetermined customizations may be displayed in the web-based application on the device as textual or graphic indications, and the device may receive the selection from the user through the web-based application. For example, a customizable graphic field for a location may be configured to receive a selection from a listing of predetermined graphic customizations for a location (e.g., a user may select from a “Safari Location” graphic customization, a “Downtown Location” graphic customization, and a “Farm Location” graphic customization, etc.). The listing of predetermined graphic customizations for the location may be displayed as textual indications (e.g., in a drop-down menu) and/or as graphic indications (e.g., as images of each of the possible graphic customizations for the location). Other examples are possible as well.

Still alternatively or additionally, some or all of the customizable fields may be configured to receive an uploaded file customization or a link customization (e.g., a link to a file accessible via, for example, the Internet or another network). For example, a customizable audio field for a sound effect may be configured to receive an uploaded sound effect audio file or a link to a sound effect audio file accessible via the Internet. Other examples are possible as well. Uploaded customizations may be uploaded from the device or from another source. In some embodiments, uploaded customizations may be checked for appropriateness and/or quality (e.g., a photograph may be checked for appropriate resolution.) Further, in some embodiments, a user may be able to modify and/or edit uploaded customizations (e.g., a photograph may cropped, changed to black and white or another color filter, etc.

While in the foregoing description a customizable text field was described in connection with alphanumeric customization, a customizable graphic field was described in connection with a selection from a listing of predetermined customizations, and a customizable audio field was described in connection with an uploaded file customization or a link customization, it will be understood that any of the customizable text field, the customizable graphic field, and the customizable audio field may be configured to receive any of the customizations described.

At block 408, the server receives from the device via the application a selection of at least one customizable field in the customizable fields. To this end, the user of the device may, for example, select through the application at least one of the customizable fields that the user wishes to customize, and the device may provide the selection to the server. The method 400 continues at block 410 where, for each of the at least one selected customizable fields, the server receives from the device via the application a customization of the selected customizable field. To this end, the device may, in response to receiving the selection of a customizable field through the application, prompt a user to provide the customization.

In some embodiments, the device may first prompt the user to select each of the customizable fields that the user wishes to customize and, once all of the selected customizable fields have been selected, prompt the user to select customizations for each of the selected customizable fields. Alternatively, the device may, for each of the customizable fields, first prompt the user to select whether the user wishes to customize the customizable field and, if the user does wish to customize the customizable field prompt the user for a customization of the customizable field, or, if the user does not wish to customize the customizable field, to continue by prompting the user to select whether the user wishes to customize another customizable field. The server may receive the selection of the at least one customizable field and the customizations of the selected at least one customizable fields in other manners as well.

In embodiments where the customizable field is configured to receive an alphanumeric customization, the device may, for example, provide a blank field into which a user can type the alphanumeric customization. Similarly, in embodiments where the customizable field is configured to receive a selection of a predetermined customization from a listing of predetermined customizations, the device may, for example, provide a drop-down menu or other menu from which the user can select the predetermined customization. Further, in embodiments where the customizable field is configured to receive an uploaded file customization or a link customization, the device may prompt the user to browse for the file customization and/or provide a blank field into which the user can type or copy and paste the link customization. Other customizations are possible as well.

In some embodiments, one or more of the customizable fields may be associated with one another. These associations may enable the device to provide and/or aid a user in determining more appropriate customizations for a customizable field once a customization for an associated customized field has been received. For example, a customizable field for character gender and a customizable field for character appearance may be associated, such that if a user provides a particular customization for the customizable field for character gender (e.g., the user provides a male customization), the device provides particular predetermined customizations to the user from which to select the customization for the customizable field for character appearance (e.g., predetermined customizations having male appearance). As another example, a customizable field for character name and a customizable field for title may be associated, such that if a user provides a particular customization for the customizable field for character name (e.g., the user provides the customization “Melanie”), the device provides particular suggestions for customizing the customizable field for title (e.g., “Melanie Saves the Day!”, “Melanie Makes a New Friend”, etc.) from which the user may select a customization for the customizable field for title and/or on which the user may base a customization for the customizable field for title. As still another example, a customizable field for pet type and a customizable field for pet graphic may be associated, such that if the user provides a particular customization for the customizable field for pet type (e.g., the user provides the customization “Parrot”), the device automatically selects a particular customization for the customizable field for pet graphic (e.g., a parrot graphic) without further input from the user. Other examples are possible as well.

The method 400 continues at block 412 where, based on the customization for each of the at least one selected customizable fields, the server customizes the customizable book to produce a customized book. To this end, the server may customize each of the selected customizable fields using the customizations received from the device. For example, if the user provided a text customization for a customizable text field, the server may include the text customization on one or more pages of the customized book. As another example, if the user provided a graphic customization for a customizable graphic field, the server may include the graphic customization on one or more pages of the customized book. As still another example, if the user provided an audio customization for a customizable audio field, the server may include instructions to play the audio customization on one or more pages of the customized book. Other examples are possible as well.

Once the book is customized, the user may wish to share the customized book with some or all of the plurality of additional users. To this end, the device may provide a listing of the plurality of additional users through the application from which the user can select one or more additional users with whom to share the customized book. Alternatively or additionally, the device may provide a blank field in the application in which the user can provide an alphanumeric indication of one or more additional users with whom to share the customized book. The device may receive the one or more additional users from the user in other manners as well. Once the device has received the one or more additional users, the device may provide indications of the one or more additional users to the server.

The method 400 continues at block 416 where, for each of the indicated additional users, the server may provide the customized book to the additional device associated with the additional user via the additional application on the additional device. Alternatively, the server may provide the customized book to the indicated additional users through email or a website. The server may provide the customized book to the indicated additional users in other manners as well. In some embodiments, the server may provide each of the additional users and/or the additional devices with a notification that the customized book has been provided. The notification may take the form of, for example, an email or a pop-up or audio notification in the application. Other notifications are possible as well. The additional users may select whether notifications are to be “pushed” to the additional devices (e.g., downloaded when available) or “fetched” to the additional devices (e.g., downloaded as requested by the additional users).

The method 400 continues at block 418 where the server causes the customized book to be printed. To this end, the server may, for example, provide the customized book to an affiliated printer, the affiliated printer may print the book, and the printed book may be provided to the user. The printed customized book may, in some embodiments, include all of the customizations of the customized book. In other embodiments, however, including those in which the customizations of the customized book include, for example, audio customizations, the printed customized book may include only a portion of the customizations of the customized book. The printed customized book may take other forms as well.

While the method 400 is shown to include both providing the customized book to indicated additional users and causing the customized book to be printed, in some embodiments the customized book may only be provided to the indicated additional users, may only be printed, or neither. Further, in some embodiments the customized story may alternatively or additionally be provided to the device.

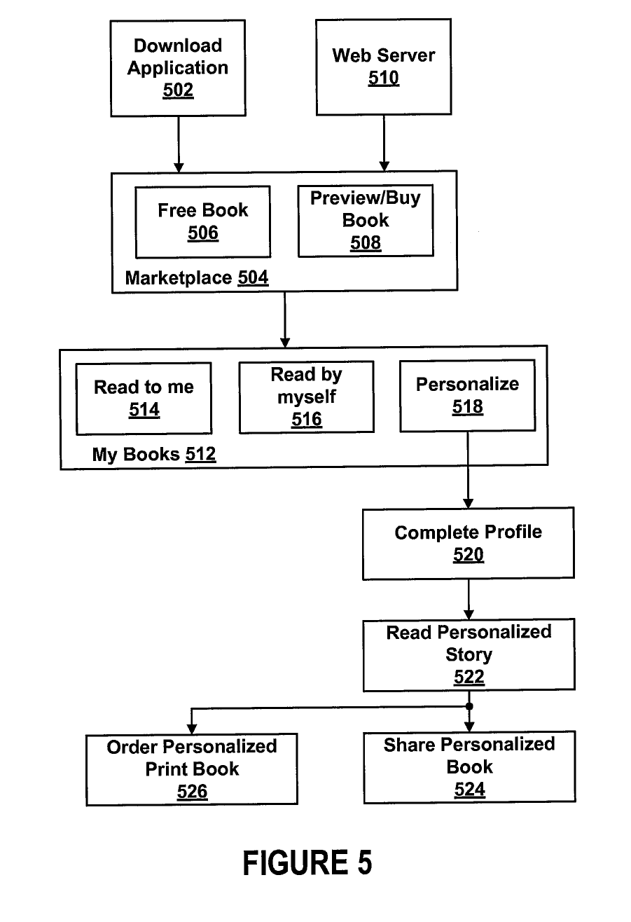

FIG. 5 shows a flow diagram of an example method for customizing a book, in accordance with an embodiment. Initially, a device may download an application, as shown at block 502, to the device and run the application to access a marketplace 504. The marketplace 504 may provide an electronic commerce marketplace at which a user may purchase or access electronic stories or books. As an example, a user may request and receive a free book 560 from the marketplace 504, or a user may request and receive a preview or purchase of a book 508 from the marketplace 504. The marketplace 504 may be provided by a server 510, for example.

The application 502 may provide a folder for storing downloaded books from the marketplace 504, such as a “my books” 512 folder. The application 502 may be configured to allow the book to be read to a user 514, read by the user 516, or personalized 518.

In some examples, to personalize the book, a profile may be completed as shown at block 520, in which user names, photos, images, information of a user, are input to the application 502. The application 502 identifies associated fields of a book at which to modify and personalize the fields. For example, the application 502 can identify a “name” field in the book to insert the name of the user profile. Other fields may be identified as well and filled with personalized information of the user.

Following, as shown at block 522, a personalized story may be read, and shared, as shown at block 524, as discussed above. In addition, a user may order a personalized print of the book, as shown at block 526.

The flow diagram in FIG. 5 illustrates examples of customizations entered locally at the device and an application running on the device may customize a downloaded book.

### 4. Example Applications

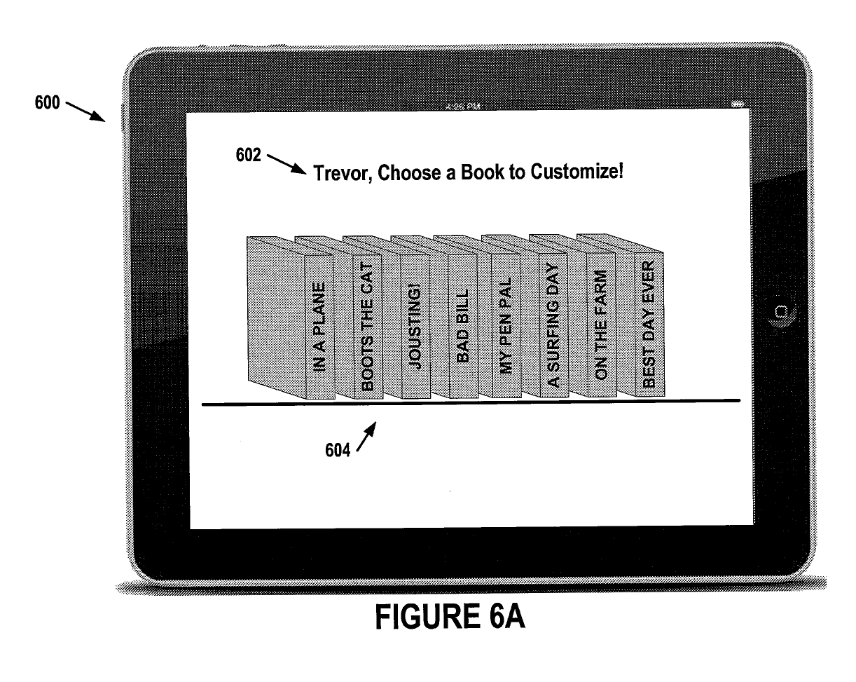

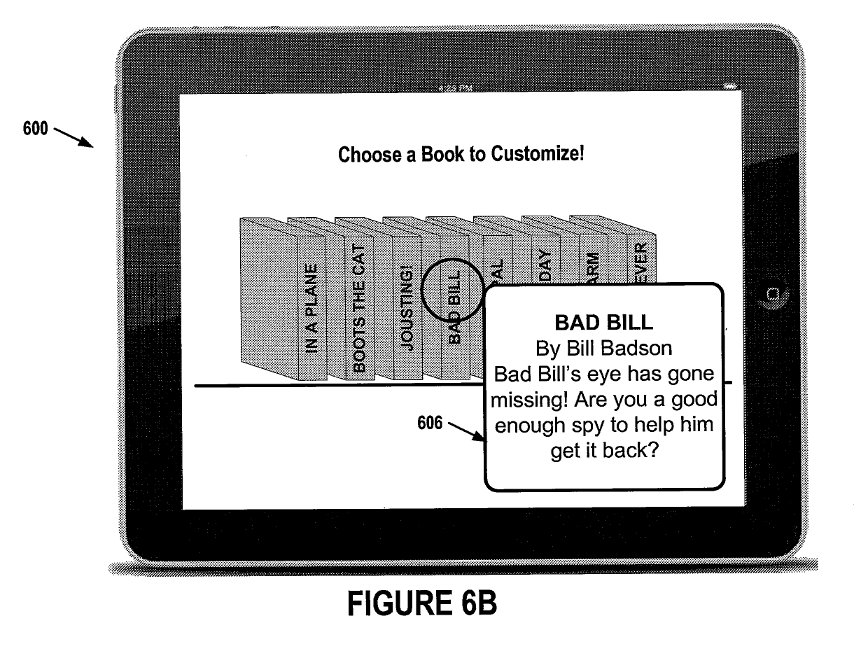

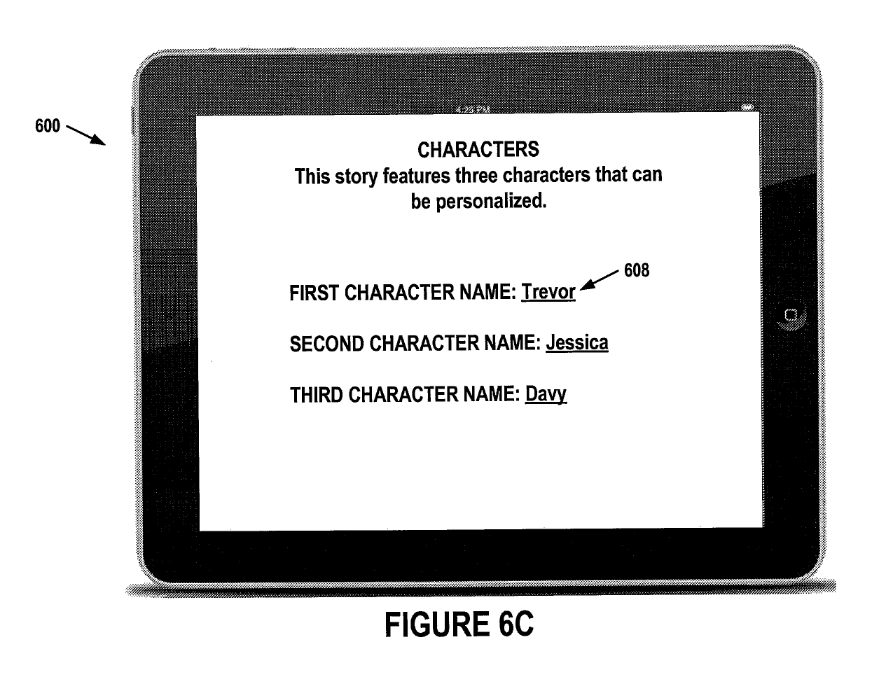

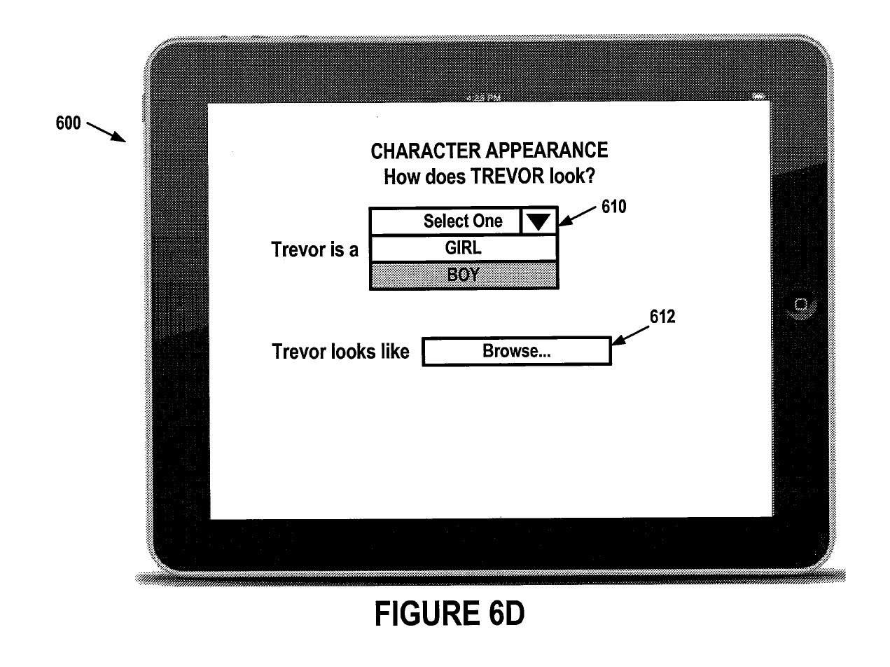

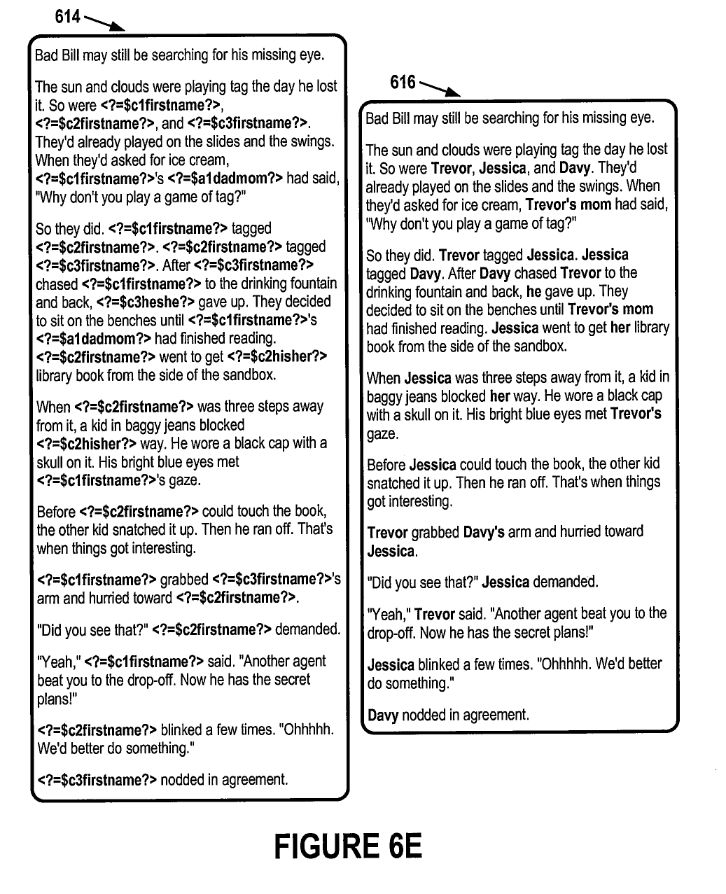

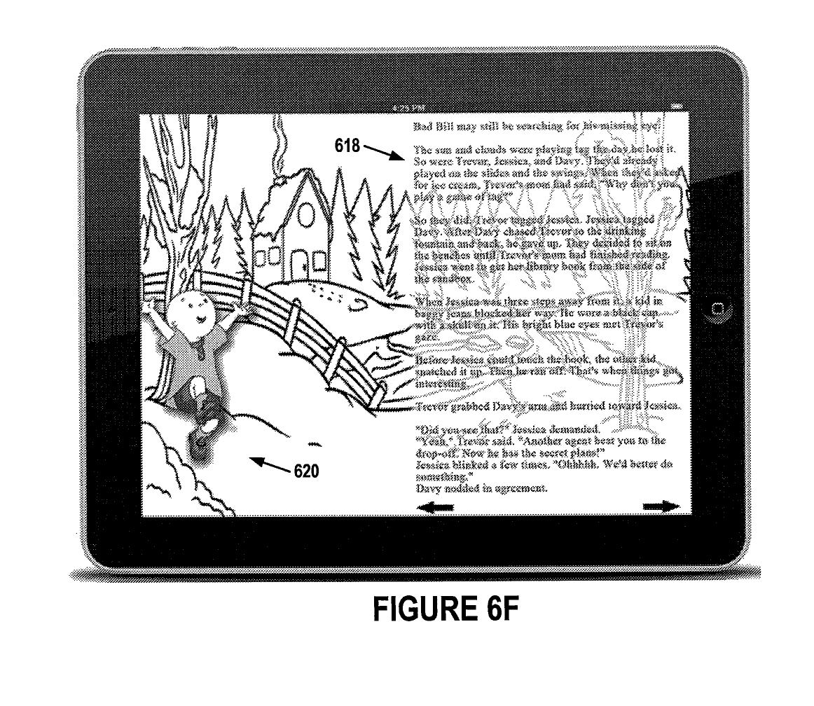

For purposes of illustration, customization of a book through an example application is described. In particular, FIGS. 6A-F illustrate an example application of the methods 400 and 500 shown in FIGS. 4-5, in accordance with an embodiment.

As shown in FIG. 6A, an application is running on a device 600. The application may provide wireless connectivity with a server, such as the server 200 described above in connection with FIG. 2. Other servers are possible as well.

The application may be configured to access a user profile for a user stored at the server, as described above. The user profile may include, for example, a name of the user (e.g., “Trevor”). Additionally, the user profile may include one or more of an email address for the user, payment information for the user, a mailing address for the user, an age of the user, a reading level of the user, appearance information for the user (e.g., brown hair, blue eyes, etc.), preferences for the user (e.g., preferred genres, etc.), and books previously customized by the user. The user profile may include other information as well.

As shown, the application may use the information in the user profile to personalize the application for the user. For example, as shown, a greeting 602 includes a name of the user (“Trevor”). Additionally, as shown, a number of customizable books 604 are offered to the user. The customizable books may be selected by the server or device based on the information in the profile, including, for example, a gender of the user, an age of the user, a reading level of the user, preferences for the user, and books previously customized by the user. The customizable books may be selected in other manner as well. Further, the application may be personalized in other manners as well.

In order to customize a customizable book, the user may select one of the customizable books 604. To this end, the user may, in some cases, request additional information about one or more of the customizable books by, for example, hovering a cursor over the customizable book, as shown in FIG. 6B. The additional information may include, for example, an author of the customizable book, a synopsis of the customizable book, and a preview of the customizable book. Other additional information is possible as well.

Once the user has selected a customizable book, the user may be prompted to provide customizations 608 for a plurality of customizable fields in the customizable book. As shown in FIG. 6C, the customizable fields include customizable text fields for three character names. While the customizations of the customizable text fields are shown as alphanumeric customizations, other customizations are possible as well. In some embodiments, the first customizable text field for a character name may be automatically populated with the name of the user (“Trevor”), as shown. The user may modify the populated customization, if desired.

FIG. 6D shows additional customizations for additional customizable fields. In particular, a customizable text field 610 for character gender is shown, along with a drop-down menu for use in selecting a customization for character gender from a plurality of predetermined customizations for character gender (“Boy”, “Girl”). Additionally, a customizable graphic field 612 for character appearance is shown, along with a “Browse” command for use in uploading an uploaded file customization. Alternatively, a blank field could be provided in the application for use in typing a link to a link customization. While the customizations are shown as customizations selected from a list of predetermined customizations and uploaded file customizations, respectively, other customizations are possible as well. In some embodiments, the one or both of the customizable text field and the customizable graphic field may be automatically populated with the gender of the user and an image of the user from the user profile for the user. The user may modify the populated customization, if desired.

FIG. 6E illustrates example source code for customizing the customizable book. As shown, the customizable book 614 may include a plurality of customizable text fields (e.g., “<?=$c1firstname?>”). In the customized book 616, each of the plurality of customizable text fields may be replaced with the customizations provided by the user (e.g., “<?=$c1firstname?>” is replaced with “Trevor”). For customizable text fields that were not customized by the user, the device may replace the customizable text field with a default or random customization.

While the customized book is shown to be customized using customization pages that include specific prompts for customizable fields, in some embodiments, customization may be performed on a page-by-page basis. To this end, each page of the customizable book may be displayed in the application, and a user may select text, graphics, and/or audio on the page (or may select an “Add New Customization” option to add new text, graphics, and/or audio), and may provide a customization for the selected text, graphics, and/or audio.

The customized book may be displayed in the application. FIG. 6F illustrates the customized book being displayed in the application. As shown, the text 618 of the customized book is displayed, along with a customized graphic 620. In some embodiments, the customized book may additionally include customized narration (e.g., narration by a parent), customized background music, customized sound effects, customized animation, and/or customized page-turn sounds. Other customizations are possible as well. In some embodiments, the audio customizations may be selectively turned off (e.g., in quiet environments).

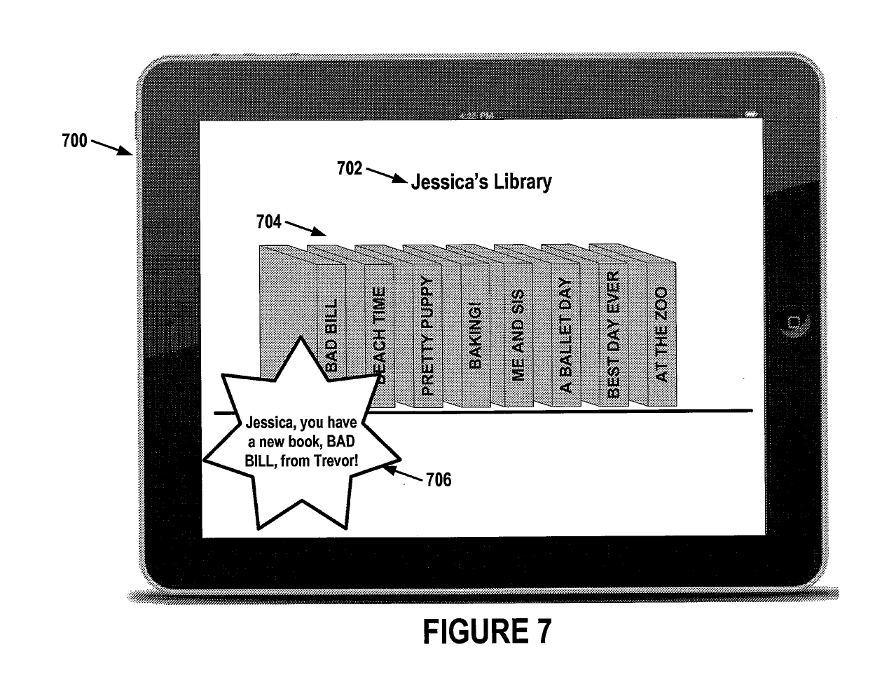

As described above, the user may share the customized book with additional users. To this end, the user may select one or more additional users at the device, and the device may provide indications of the one or more additional users to the server. The server may provide the customized book to an additional device associated with the additional user through, for example, an additional application on the additional device. FIG. 7 illustrates an example additional application, in accordance with an embodiment.

As shown in FIG. 7, the additional application on the additional device 700 is customized for an additional user of the additional device 700. For example, as shown, a greeting 702 includes a name of the user (“Jessica”). The application may be personalized in other manners as well.

A number of customized books 704 that were previously customized by or shared with the additional user are displayed in the application. Further, as shown, the application is displaying a notification 706. The notification 706 indicates that a user has shared a customized book with the additional user. While the notification 706 is shown as a pop-up notification, other notifications are possible as well.

### 5. Alternative Embodiments

a. Customization by a Parent

In some embodiments, a user of a device may customize a customizable book for another user's profile. For example, a parent (or other caregiver) of a young child may create a user profile for his or her child and customize books using the child's profile. The customized books may thus be customized according to the child's preferences, rather than the parent's.

Additionally, the user of the device may share the customized book with an additional device that is used by the user whose profile was used. For example, the parent of the young child may share the customized book with an additional device that is used by the child. In this manner, the parent may customize the customizable book on a parent-friendly and/or customization-friendly device and share the customized book with a child-friendly device used by the child.

In some embodiments, the parent may include in the customized book one or more audio customizations featuring the parent's voice. For example, the parent may read aloud the customized story and record an audio file to be used as narration with the customized book. As another example, the parent may record an audio file to be used as a dedication (e.g., “To”, “From”, and/or a personal message) at the beginning of the customized book. As still another example, the parent may record an audio file of the child's name, which may be spliced with predetermined narration to ensure correct pronunciation. Other examples are possible as well. Such audio customization may, for example, provide an improved substitute for personal contact during times that the parent is busy.

b. Fully-Customizable Books

While the foregoing description focused on customizable books having predetermined text and/or graphics along with a plurality of customizable fields, in some embodiments, the entirety of a book may be customizable fields. In these embodiments, a user may draft his or her own text, select his or her own graphics, and create his or her own formatting and layout using the web-based application. In this manner, a user may create a fully-customized book.

c. Customization Database

In some embodiments, the server may maintain a database of customizations that a user may select for a customizable field. The customizations may include text customizations, graphic customizations, and audio customizations. A user may access the database of customizations through the web-based application. For example, for each customizable field, a browse command or other command may be provided. Upon clicking on the browse command, the user may browse the database of customizations in order to locate a customization the user likes. Other examples are possible as well.

To aid the user in locating a desirable customization, the database of customizations may be organized according to one or more tags on each customization. Such tagging may aid in both categorization and searching of the customizations.

Some customizations may be predetermined and stored in the customization database. These predetermined customizations may include predetermined tags indicating, for example, whether the customization is a text, graphic, or audio customization, a title of the customization, and one or more attributes of the customization. Other tags are possible as well.

Other customizations may be provided by users and, once provided, stored in the customization database (e.g., automatically or pending permission from the users). When such customizations are added to the customization database, they may be tagged by the user. For example, if a user uploads a photograph of a dog, and agrees to store the photograph in the customization database, the user may tag the photograph with tags indicating, for example, that the photograph is a graphic customization, a title of the photograph, a year in which the photograph was taken, and one or more attributes of the photograph. Other examples are possible as well.

In some embodiments, a user may also add tags to the predetermined customizations, such as a “Favorites” tag or a tag indicating an appropriate reading level. These tags may help the user relocate the predetermined customization later. Further, these tags may help other users determine which predetermined customizations are most appropriate for their customized books.

In some embodiments, the customizable books may be tagged in a manner similar to that described above for the customizations. The customizable books may include predetermined tags, such as tags indicating a title of the customizable book, an author of the customizable book, a genre of the customizable book, and a reading level of the customizable book. Other predetermined tags are possible as well. The customizable books may further include tags added by users, such as “Favorites” tags, as described above.

Through tagging of the customizations and the customizable books, a user may more easily search for and select customizations and customizable books. In some embodiments, hierarchical tagging may be employed, allowing hierarchical searching. For example, a user may search for customized books about dogs, and, within the customized books about dogs, customized books about poodles. Other examples are possible as well.

d. Interactive Customized Story

In some embodiments, the customized story may include one or more customizations that result in the customized story being interactive. For example, a user may select an audio customization for a sound effect that happens when a particular graphic on the screen is selected. As another example, a user may select a graphic customization for an animation that happens when a particular input is received (e.g., trees may appear to blow in the wind when a user blows into a microphone included in or coupled to the device). Other examples are possible as well.

e. Public and Private Customized Books

While the foregoing description focused on a user sharing a customized book with a selected group of additional users, in some embodiments the user may simply designate the customized book as public or private. For example, the user may designate the customized book as public, such that anyone may access the customized book through a web-based application. As another example, the user may designate the book as private, such that only a particular group of additional users may access the customized book. The particular group of additional users may include, for example, additional users with whom the user is connected on one or more social media sites and/or additional users previously selected by the user. Other examples are possible as well.

f. Offline Customization

In some embodiments, a customizable book may be downloaded along with a toolkit of predetermined customizations for customizing the customizable book. Once the customizable book and the toolkit are downloaded, the customizable book may be customized offline (that is, without connection to the internet and, in turn, the server). Such customization may, in some cases, prove enjoyable to children, who may continually customize the customizable book using the toolkit of predetermined customizations. In some cases, in addition to the toolkit of predetermined customizations, the user may supply customizations that may be used during offline customization. Alternatively or additionally, in some cases, the user may select customizations in customized books on the device for inclusion in the customizable book.

In some embodiments, when the device again connects to the server, the device may prompt the user to upload the customized book to the server and/or to share the customized book with one or more additional users, as described above.

### CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
providing an application on a device;
for each of a plurality of additional users, providing an additional application on an additional device associated with the additional user;
receiving from the device via the application a selection of a customizable book from a plurality of customizable books, wherein the customizable book comprises a plurality of customizable fields;
receiving from the device via the application a selection of at least one customizable field in the plurality of customizable fields;
for each of the at least one selected customizable fields, receiving from the device via the application a customization of the selected customizable field;
based on the customization for each of the at least one selected customizable fields, customizing the customizable book to produce a customized book;
receiving from the device via the application an indication of at least some of the plurality of additional users;
for each of the indicated additional users in the plurality of additional users, providing the customized book to the additional device associated with the additional user via the additional application on the additional device; and
causing the customized book to be printed.

2. The method of claim 1, wherein each customization comprises at least one of a text customization, a graphic customization, and an audio customization.

3. The method of claim 2, wherein the text customization comprises at least one of a title customization, a dedication customization, a character name customization, a location name customization, and an object name customization.

4. The method of claim 2, wherein the graphic customization comprises at least one of a cover appearance customization, a font customization, a page-turn appearance customization, a character appearance customization, a location appearance customization, and an object appearance customization.

5. The method of claim 2, wherein the audio customization comprises at least one of a narration customization, a dedication customization, a background music customization, a page-turn audio customization, and a sound effects customization.

6. The method of claim 1, wherein providing the customized book to the additional device associated with the additional user via the additional application on the additional device comprises causing the additional application to display a notification of the customized book.

7. A server comprising:
at least one interface;
at least one processor; and
data storage comprising (i) a plurality of customizable books and (ii) instructions executable by the at least one processor to:
provide via the at least one interface a web-based application on a device;
for each of a plurality of additional users, provide an additional web-based application on an additional device associated with the additional user;
receive from the device via the web-based application a selection of a customizable book from the plurality of customizable books, wherein the customizable book comprises a plurality of customizable fields;
receive from the device via the web-based application a selection of at least one customizable field in the plurality of customizable fields;
for each of the at least one selected customizable fields, receive from the device via the web-based application a customization of the selected customizable field;
based on the customization for each of the at least one selected customizable fields, customize the book to produce a customized book;
receive from the device via the web-based application an indication of at least some of the plurality of additional users;
for each of the indicated additional users in the plurality of additional users, provide the customized book to the additional device associated with the additional user via the additional web-based application on the additional device; and
cause the customized book to be printed.

8. The server of claim 7, wherein the at least one customization comprises at least one of a text customization, a graphic customization, and an audio customization.

9. The server of claim 7, wherein the at least one interface comprises a wireless interface.

10. A device comprising:
at least one interface configured to facilitate provision by a server of a web-based application;
at least one processor; and
data storage comprising instructions executable by the at least one processor to:
receive via the web-based application a selection of a customizable book from a plurality of customizable books, wherein the customizable book comprises a plurality of customizable fields;
receive via the web-based application a selection of at least one customizable field in the plurality of customizable fields;
for each of the at least one selected customizable fields, receive via the web-based application a customization of the selected customizable field;
receive via the web-based application a selection of a plurality of additional users;
provide to the server via the at least one interface indications of the customizable book, the at least one customizable field, the customization for each of the at least one selected customizable fields, and the plurality of additional users for use by the server in customizing the customizable book to produce a customized book;
in response to providing the indications to the server, receive from the server via the at least one interface (i) a confirmation that the customized book has been provided to each additional user in the plurality of additional users and (ii) a confirmation that the customized book has been printed.

11. The device of claim 10, wherein the device comprises at least one of a tablet computer, an electronic reader, and a mobile device.

12. The device of claim 10, wherein the at least one interface comprises a wireless interface.

13. The device of claim 10, further comprising a display configured to display at least one of a listing of the plurality of customizable books, the plurality of customizable fields, the customization for each of the at least one selected customizable fields, a listing of the plurality of additional users, the confirmation that the customized book has been provided to each additional user in the plurality of additional users, and the confirmation that the customized book has been printed.

14. The device of claim 10, wherein the display comprises a touchscreen.

15. The device of claim 14, wherein the display is further configured to receive at least one of the selection of the customizable book from the plurality of customizable books, the selection of the at least one customizable field, and the selection of the selection of the plurality of additional users.

16. The device of claim 10, further comprising at least one input configured to receive at least one of the selection of the customizable book from the plurality of customizable books, the selection of the at least one customizable field, and the selection of the selection of the plurality of additional users.

17. The device of claim 10, wherein the at least one customization comprises at least one of a text customization, a graphic customization, and an audio customization.

18. The device of claim 10, wherein the instructions are further executable by the at least one processor to receive payment for the customized book via the web-based application.

19. The device of claim 10, wherein the instructions are further executable by the at least one processor to:
display via the web-based application an indication of the customized book;
receive via the web-based application a selection of the customized book;
in response to receiving the selection of the customized book, download at least a portion of the customized book from the server via the at least one interface; and
display via the web-based application the at least a portion of customized book.

20. The device of claim 19, wherein displaying via the web-based application the at least a portion of the customized book comprises:
displaying via the web-based application a page from the customized book; and
caching at least one of a preceding page and a following page on the device.
